(19) United States
(12) Patent Application Publication
(10) Pub. No.: US 2007/0073795 A1
(43) Pub. Date: Mar. 29, 2007

(54) Method and apparatus for calculating an inverse dct

(76) Inventors: Richard M. Miller, Oxted (GB); David E. Penna, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/575,651

(22) PCT Filed: Oct. 15, 2004
(86) PCT No.: PCT/IB04/52104

§ 371 Date: Apr. 14, 2006

(30) Foreign Application Priority Data
Oct. 18, 2003 (GB) 0324369.8

(51) Int. Cl. G06F 17/14

(52) U.S. Cl. 708/400

(57) ABSTRACT

A method, and associated apparatus is described for calculating an inverse transform for transform coded data. In a main embodiment, an 8×8 Discrete Cosine Transform (DCT) (200) is arranged in columns of coefficients (202,204,206), the last coefficient is selectively modified to control mismatch in a known manner. The inverse DCT is performed selectively so as to apply abbreviated processing to groups composed entirely of zero-valued coefficients (204). For the purpose of selecting whether abbreviated processing is to be applied, a data group (206) is considered a zero-valued group if the only non-zero coefficient contained therein is a coefficient modified for mismatch control. Further the effect that the modified coefficient has on the output can be pre-calculated, said pre-calculated values being used to compensate for ignoring the non-zero coefficient.

The invention relates to video encoding/decoding and in particular to calculation of inverse transforms such as the fast implementation of inverse discrete cosine transform for MPEG Video decoding taking into account mismatch control.

A two-dimensional 8×8 discrete cosine transform (DCT) is used at the heart of MPEG (Moving Picture Expert Group) standards such as MPEG 1 and MPEG 2 video coding. A number of methods to quickly calculate both the DCT (used during encode) and inverse-DCT (used during decode) have been published. However, these describe mathematical methods to calculate the result quickly.

MPEG decoding includes several parts such as variable length decoding, the IQ/DCT stage and the motion reconstruction phase. The IQ and DCT phase is used in two ways, one way is in so called ‘Intra’ macroblocks where the output image values are described directly by the output of the DCT, the other is in ‘non-Intra’ or ‘Inter’ macroblocks where the DCT output is used as a corrective term by the addition of the output on top of the motion reconstruction.

The inverse quantisation (IQ) stage turns the values coded in the bitstream into values ready for input to the inverse DCT transformation.

The standard way to implement the 2-D 8×8 IDCT in software is by using multiple 1-D IDCT of length 8. This is first done in one dimension (for example acting on each row from top to bottom), then in the other dimension (for example each column, left to right). Throughout this specification we will assume that the IDCT acts on the column data first, then on the rows. However, the method is applicable to implementations that work the other way round and implementations that use direct 2-D IDCT.

It is the nature of the IDCT that zero valued input data produces zero valued output data. Furthermore, it is more likely that a coefficient will be non-zero the closer it is to the first (i.e. top left or DC) coefficient. Indeed, the fact that quantised coefficients away from the top left corner are likely to be zero or near-zero is why the IDCT is useful in video coding.

The simplest case of an IDCT implementation would be to do a full 8×8 transform for all sets of input values. However, it is known that some software implementations are set-up such that known regions of zero input data to the IDCT transform are ignored. Usually this implies some logic in the IQ loop to enable calculation of a value that determines which method to use.

Two such methods are described below. One is a looping method where column IDCTs are only calculated if one of the coefficients in a column is non-zero. In this case there is a section of code which is run to process one column, and this code is only run for those columns which have non-zero input coefficients.

The other is where a decision is made to use one of a number of highly optimized versions of the IDCT routines before the IDCT is run. These routines differ in the different configurations of coefficient columns/rows they assume to be zero. In this case there is a process which will choose, from a set of pre-defined routines, the quickest routine which can correctly transform an 8×8 block, given knowledge of which columns have non-zero coefficients.

Both these example methods reduce the number of operations (such as multiples and additions) that have to be done per IDCT, on the assumption that there are many columns or rows of all-zero coefficients.

In standard usage it would be expected that the probability of each of these IDCT types being run would be reasonably high. However, in MPEG 2 video coding a particular method known as mismatch control alters the least significant bit of the last coefficient in a high proportion of input data sets, even if the column occupancy is very low. The effect of mismatch control is that the encoder will flip the least significant bit of the last coefficient if the sum of the coefficients at the input of the IDCT is even.

This coefficient is in the column otherwise least likely to contain non-zero coefficients. In the first method described above (looping over columns) this will mean that the final column will be fully processed even though the mismatch bit is all that is set.

If the second method is in use then the decoder will often not be able to use optimized routines which are only useful if the final column is all zero. Since this column is (apart from mismatch control) the least likely to contain non-zero values, many optimised routines designed on the basis of typical MPEG stream statistics will only be useful for cases where this column is zero. The presence of the mismatch bit will have forced the use of a more expensive routine.

Implementation of mismatch control is required to conform to the MPEG 2 specification. Its purpose is to prevent IDCT rounding errors accumulating over a set of images each of which derives from the one before though motion prediction. Discussion of mismatch control and its implementation is included for example in U.S. Pat. No. 6,456,663 and U.S. Pat. No. 5,604,502. However, neither addresses the particular issue identified above.

An object of the present invention is to simplify and increase the speed of an inverse transform such as the IDCT calculation by taking into account mismatch status.

The invention provides in a first aspect a method of calculating an inverse transform for transform coded data, said coded data being arranged in groups of coefficients, wherein at least one coefficient is selectively modified to control mismatch, wherein the inverse transform is performed selectively so as to apply abbreviated processing to groups composed entirely of zero-valued coefficients, and wherein, for the purpose of selecting whether abbreviated processing is to be applied, a data group is considered a zero-valued group if the only non-zero coefficient contained therein is a coefficient modified for mismatch control.

Said transform coded data may be discrete cosine transform coded data, for example as part of MPEG-2 encoded video data.

The data may be arranged in a two-dimensional (for example 8×8) array. A two-pass approach of multiple 1-D inverse transforms may be applied, and each data group may be a column or a row of said array, depending on whether vertical inverse transform or horizontal inverse transform is performed first.

The second pass inverse transform routine may be made on the basis of the combinations of non-zero valued groups. This may be achieved by having a number of variations of a second pass process executable code pre-stored, each variation corresponding to a combination of non-zero groups present in the first pass, the code determining on which coefficients calculation is performed. Further, the second pass code may be adapted to ignore data from unprocessed input groups. Otherwise, when a column was assumed zero it would be necessary to clear columns of memory before the second pass.

As an alternative to the two-pass approach, a direct 2-D implementation may be used, and the groups assumed zero may be 2-D blocks of coefficients. Again, any coefficient set purely for mismatch control can be disregarded for the purposes of determining whether abbreviated processing applies.

Preferably the coefficient modified for mismatch control is the last coefficient, that is the bottom right hand corner coefficient of the array.

In preferred embodiments an inverse transform of the data group containing the coefficient modified for mismatch control is pre-calculated and used in calculating the inverse transform. The pre-calculated inverse transform will be 1-D or 2-D, as appropriate.

In a first embodiment the inverse transform for each data group is calculated only for data groups which, before modification for mismatch control, include a non-zero coefficient and wherein, if mismatch is indicated, pre-calculated output values are used for the data group having the modified coefficient.

It is not essential that the decision to abbreviate calculation is made on a group-by-group basis. The cost of deciding which course to follow brings an overhead in itself and accordingly it may be preferable to define certain predefined routines, which are then applied over a range of conditions.

In an alternative embodiment, therefore, the number of non-zero data groups and each of their positions is determined before performing the inverse transform for any of the groups and a routine is selected from a number of possible routines, depending on the configuration of non-zero groups and their positions.

In one such embodiment:
where there is at least one non-zero group outside a subset of said groups, said subset possibly comprising the first three groups, the inverse transform is calculated for all groups; and
where there are no non-zero groups outside said subset, then the inverse transform is calculated for said subset and not for the remaining groups, and, if the modified coefficient is non-zero, pre-calculated values are used to reproduce the effect of the modified coefficient in the inverse transform.

These routines may be further optimized such that:
where the only non-zero data groups is the first column, the inverse transform is calculated in two dimensions for the non-zero data group only, and if the modified coefficient is non-zero, pre-calculated values of the effect the modified coefficient has on each output value are then added; and/or
if only the DC (that is top left) coefficient is non-zero, all output values are set to the value of the DC coefficient and if the modified coefficient is non-zero, pre-calculated values of the effect the modified coefficient has on each output value are then added.

In a further aspect of the invention there is provided decode apparatus comprising means for calculating an inverse transform for transform coded data, said coded data being arranged in groups of coefficients, wherein at least one coefficient is selectively modified to control mismatch, wherein there is further provided means for performing selectively the inverse transform so as to apply abbreviated processing to groups composed entirely of zero-valued coefficients, and wherein, for the purpose of selecting whether abbreviated processing is to be applied, a data group is considered a zero-valued group if the only non-zero coefficient contained therein is a coefficient modified for mismatch control.

Further optional features relating to this apparatus are as claimed in the appended claims.

In a yet further aspect of the invention there is provided a record carrier wherein are recorded program instructions for causing a programmable processor to perform the steps of the method described above or to implement an apparatus as described above.

Embodiments of the invention will now be described, by way of example only, by reference to the accompanying drawings, in which:

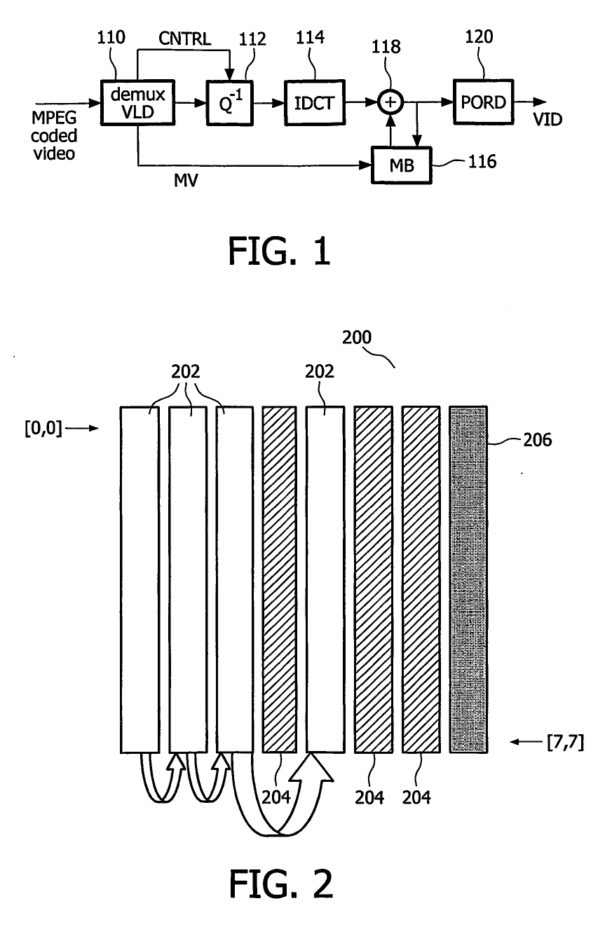

FIG. 1 shows a block diagram of an MPEG decoder;

FIG. 2 shows an 8×8 discrete cosine transform prior to IDCT being performed using a first method of the invention;

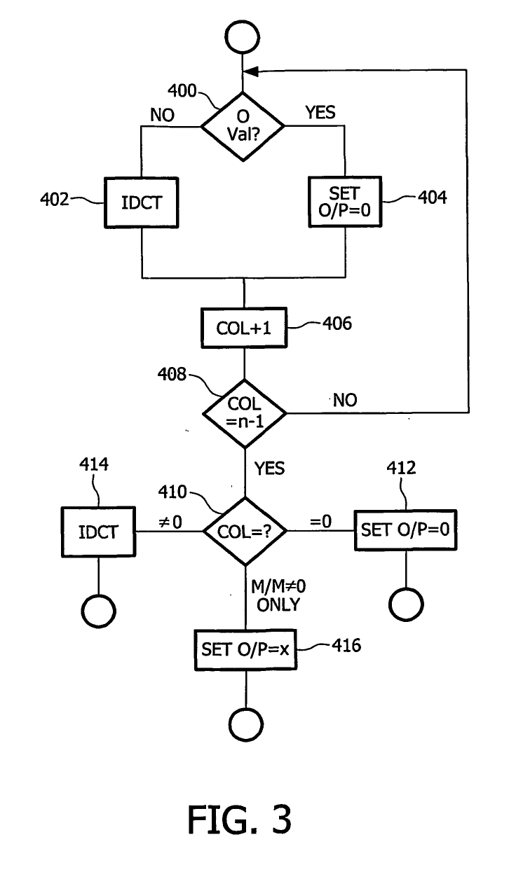

FIG. 3 is a flowchart representation of a first method of the invention;

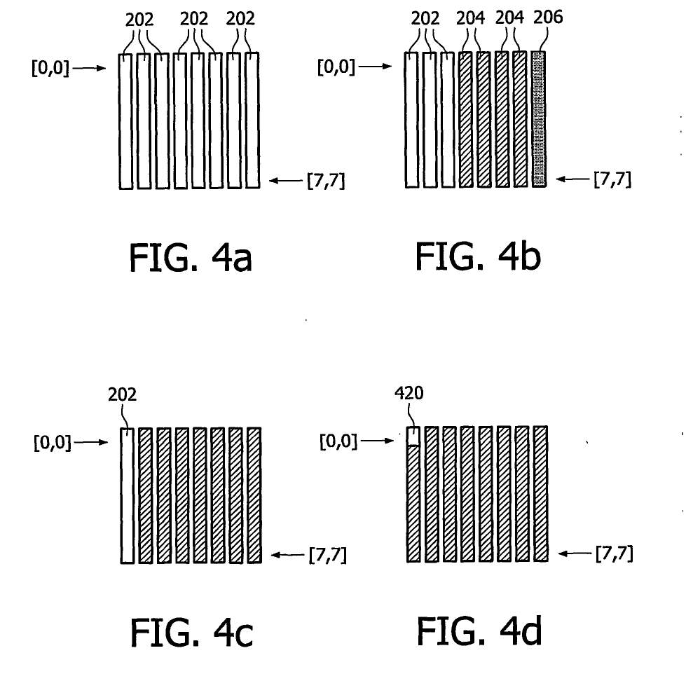

FIGS. 4a to 4d shows four 8×8 discrete cosine transforms prior to IDCT being performed using a second method of the invention; and

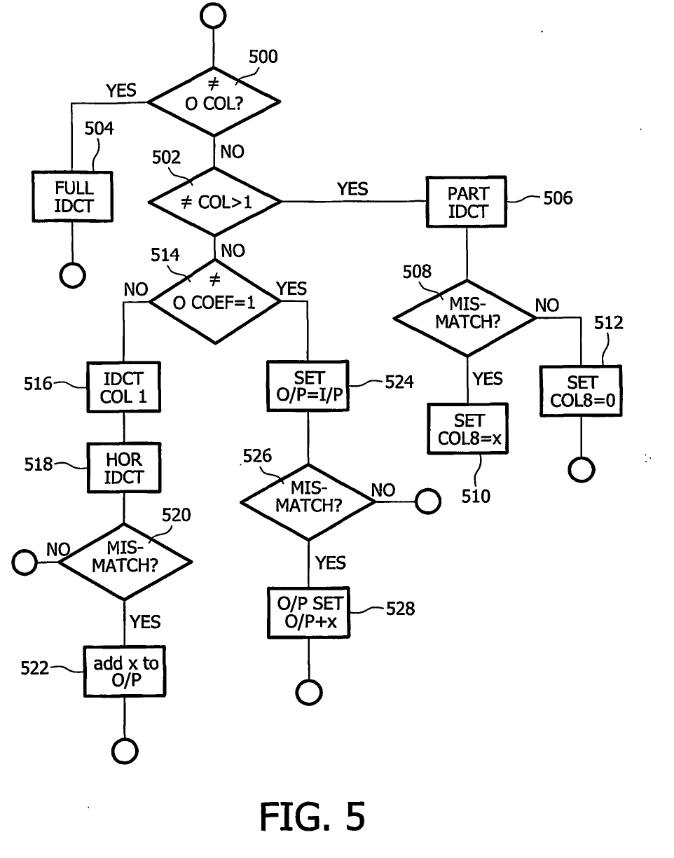

FIG. 5 is a flowchart representation of a second method of the invention.

FIG. 1 shows an MPEG decoder as used in an embodiment of the invention. The decoder consists of the functions: variable length decoder (VLD) 110, inverse quantizer 112, inverse discrete cosine transform (IDCT) process 114, motion buffer 116, summing process 118, and a picture ordering process 120.

Conventionally, the MPEG encoded video is fed into VLD 110 (often via a buffer (not shown)) and decoded into quantized DCT coefficients, which are then inverse quantized by the inverse quantizer 112. The DCT coefficients are then fed into the IDCT process 114, which performs an inverse digital cosine transform on the coefficients thus outputting the spatial pixel data. This is sent either directly to the picture ordering process 120, if an intra frame. If not an intra frame, there is motion compensation provided by the motion buffer 116 and summing process 118. The present description concerns only the IDCT process 114, and the other functions of the decoder will not be discussed further.

Throughout this description one implementation of the IDCT (using a two stage approach of multiple 1-D IDCTs) is described. Some ideas in this patent application are applicable to other implementation (such as direct 2-D IDCTs)

An example of a first method of calculating the IDCT is shown with respect to FIG. 2. This shows an 8×8 transform 200 arranged in columns 202,204,206 (as it is the vertical transforms performed first (in this case)), each column being made up of 8 coefficients. White columns 202 are those which contain at least one non-zero coefficient (non-zero columns). The hatched columns 204 are those whose coefficients are all zero (zero columns). The eighth (filled) column 206 contains the mismatch coefficient in the eighth row (mismatch is indicated by the least significant bit of coefficient [7,7].)

Due to the nature of the DCT there is most likely to be non-zero coefficients in the top left corner [1,1] of the transform, with the probability decreasing as you approach the bottom right corner. Consequently, many transforms have whole columns of zeros, biased to the right of the transform. Zero columns do not require full IDCT as the IDCT of zero is zero. Therefore calculation time can be saved by not performing an IDCT on zero columns.

In FIG. 2 there are four non-zero columns 202 and three zero columns 204 (column eight will be considered below). When IDCT is performed on this transform, the column is checked for the presence of any non-zero coefficients prior to the output of that column being determined. If a non-zero column 202 is encountered then the IDCT is performed on that column, after which the next column is checked. If, however, a zero column 204 is encountered then this is skipped and no IDCT is performed. Instead the output is simply set to zero for this column.

Turning now to column eight 206, this contains the mismatch coefficient (i.e. coefficient [7,7] set by the mismatch control). If there is no coefficient data for this column and if mismatch is present then the mismatch coefficient is the only non-zero coefficient in the eighth column. Since there was no coefficient data for this position then this value is either zero, or one. For either case the output value for the whole column can be pre-calculated (and is trivially zero for the zero case). This means that IDCT need not be calculated for this column even if mismatch is set, as is often the case. This represents a significant saving as, without mismatch control, this column would tend to be zero in the majority of cases.

FIG. 3 is a flowchart representation of the above method. At step 400 it is determined whether the column being considered (here, the first column) is a zero-valued column. If no, at 402 IDCT is performed on this column. If yes at 404, the column output is set to zero. At 406, the column being considered is incremented. At 408, it is determined whether the column being considered is the last column. If not, steps 400-406 are repeated for this next column. If, however, this column is the last, at step 410 the status of this column is determined. If it has any non-zero coefficient, other than the mismatch coefficient, then, at 414, IDCT is performed on this column. If the column is zero, then at 412, the output is set to zero. If only the mismatch coefficient is set for this column, then at 416 the output is set to a pre-calculated value.

Further economy can be gained by running the second pass routine on the basis of the combinations of columns actually present (that is non-zero). This is similar to the above method of doing the first pass whereby the second pass is a loop. If, say columns 0, 3 and 4 are the only columns processed in the first pass then much of the arithmetic in the second pass processing may be unnecessary as we know that many input values (those for columns 1, 2, 5, 6 and 7) are zero. It is better, therefore, to have a number of variations on the loop code stored for the various combinations of columns actually present in the first pass. It is probably impractical to have variations stored for all 256 cases, as this may cause l-cache problems given the large amount of code. As many of these cases will be highly improbable, while others common, a significant gain can be made with the storing of only a relatively small number of variations.

Furthermore, if full row processing were always done, it would be necessary to clear columns of memory during the first pass where a column is assumed zero. If by contrast, the second pass code will be chosen to ignore data from unprocessed input columns, then there is a further economy since the clear operation is not needed, as the values will never be used.

A second method of calculating the IDCT is shown in relation to FIGS. 4a to 4d. In this method column occupancies are determined as a first step. Depending on the number and position of non-zero columns, a particular routine is used to calculate the IDCT. Such a routine may, for example, only process the first three columns. Furthermore, as the mismatch coefficient is only ever 1 when mismatch is set and column occupancy is low, it is possible to pre-calculate the effect this has on the IDCT for a number of different situations, and use these pre-calculations when calculating the IDCT. It should be noted that the second pass routine described above is also applicable to this method.

In this method it is determined whether there are any non-zero columns outside the first three. If so, then the full IDCT is calculated in the conventional manner. Such a situation is depicted in FIG. 4a. This shows a situation where there are a number of non-zero columns 202 after column three. Consequently, even where there is only a single non-zero column after column three, such as when only columns one and five are non-zero, the full IDCT is calculated.

FIG. 4b shows a transform where there is more than one non-zero column 202 although none outside the first three columns, with column eight 206 possibly having mismatch set (at [7,7] in this example). Here, only the IDCT of the first three columns is calculated conventionally. Columns 4 to 7 are simply set to zero while the coefficients of column eight are set to the pre-calculated values if mismatch is set.

FIG. 4c shows a transform where only the first column 202 is non-zero. In this case only the first (non-zero) column has the IDCT calculated. The Horizontal IDCT is then calculated, this being fast and trivial in that it is equal to the first value in each row. Then, if mismatch is set, pre-calculated values of the effect the mismatch has on each output position are added;

FIG. 4d shows a transform with only one non-zero coefficient 420 (the DC coefficient at [0,0]). In this case the IDCT for all pixels is trivially equal to the scaled input value. If mismatch is set here, each output is set to the sum of this value and a per-position pre-calculated value of the effect the mismatch has on this value.

FIG. 5 is a flowchart representation of this second method. At 500 it is determined whether there is any non-zero column outside the first three (counting a column as zero if it contains only the mismatch coefficient=1). If yes, then at 504 the full IDCT is calculated. If not then at 502, it is determined whether the number of non-zero columns (discounting the mismatch coefficient) is greater than one. If it is, at 506, partial IDCT is performed on the first three columns, the next four columns having outputs set to zero. At 508, it is determined whether the mismatch coefficient is set. If no, the output for column eight, at 512, is set to zero. If yes, at 510, this output is set to a pre-calculated value.

If, however, at 502, the number of non-zero columns is one, it is determined at step 514, whether there is just a single non-zero coefficient in this column. If not, at column 516, the IDCT is performed on this column, followed by the horizontal IDCT 518. It is then determined, at 522, if the mismatch coefficient is set. If so then at 522 the pre-calculated values are added to the output as previously described.

However, if there is just the single non zero coefficient at 514, then the output is set to the scaled input 524, mismatch is determined at 526, and if found, at 528 the output is set to the sum of this and a pre-calculated per-position value as also previously described.

It should be noted that the foregoing description gives examples only, and other examples and embodiments are envisaged without departing from the spirit and scope of the invention. In particular, the order of the calculation is arbitrary, and rows can be calculated before the columns. Also the routines of the second method that are shown are specific examples only, and other routines may be envisaged, or these routines may differ in minor detail (such as the number of non-zero columns needed for a particular routine to be run).

A direct 2-D IDCT implementation may be used instead of the two stage approach of multiple 1-D IDCTs described above. This results in special cases where part of the input coefficient space can be assumed to be zero. This makes a significant amount of arithmetic redundant (multiplying by zero is not very useful). Consequently, as in the 1-D implementation, cases arise for which various output regions can be assumed zero. However, in this case they need not just be omitted rows/columns, but may instead be 2-D blocks, such as (for example) the coefficients present in the top left 4×4 region. These blocks can be selected in a similar manner to the cases described in relation to the 1-D implementation. Consequently, as with these examples provision may be made for a mismatch-set bit in the coefficient at position [7,7].

1. A method of calculating an inverse transform for transform coded data (200), said coded data being arranged in groups of coefficients (202,204,206), wherein at least one coefficient is selectively modified to control mismatch, wherein the inverse transform is performed selectively so as to apply abbreviated processing to groups composed entirely of zero-valued coefficients (204), and wherein, for the purpose of selecting whether abbreviated processing is to be applied, a data group (206) is considered a zero-valued group if the only non-zero coefficient contained therein is a coefficient modified for mismatch control.

2. A method as claimed in claim 1 wherein said transform coded data is discrete cosine transform coded data.

3. A method as claimed in claim 2 wherein said discrete cosine transform coded data forms part of MPEG-1 or MPEG-2 encoded video data.

4. A method as claimed in claim 1 wherein the data is arranged in a two-dimensional array.

5. A method as claimed in claim 4 wherein said two-dimensional array is an 8×8 array.

6. A method as claimed in claim 1 wherein a two-pass approach of multiple 1-D inverse transforms is applied.

7. A method as claimed in claim 6 wherein each data group (202,204,206) is a column or a row of said array, depending on whether vertical inverse transform or horizontal inverse transform is performed first.

8. A method as claimed in claim 6 wherein the second pass inverse transform routine is made on the basis of the combinations of non-zero valued groups (202).

9. A method as claimed in claim 8 wherein a number of variations of a second pass process executable code are pre-stored, each variation corresponding to a combination of non-zero groups (202) present in the first pass, the code determining on which coefficients calculation is performed.

10. A method as claimed in claim 9 wherein the second pass code is adapted to ignore data from unprocessed input groups.

11. A method as claimed in claim 1 wherein a direct 2-D implementation is used.

12. A method as claimed in claim 11 wherein the groups assumed zero are 2-D blocks of coefficients.

13. A method as claimed in claim 4 wherein the coefficient modified for mismatch control is the last coefficient.

14. A method as claimed in claim 1 wherein an inverse transform of the data group containing the coefficient modified for mismatch control is pre-calculated and used in calculating the inverse transform.

15. A method as claimed in claim 1 wherein the inverse transform for each data group is calculated only for data groups (202) for which, discounting any mismatch modification, there is a non-zero coefficient and wherein, if mismatch is indicated, pre-calculated output values are used for the data group (206) having the modified coefficient.

16. A method as claimed in claim 1 wherein the number of non-zero data groups (202) and each of their positions is determined before performing the inverse transform for any of the groups and a routine is selected from a number of possible routines, depending on the configuration of non-zero groups (202) and their positions.

17. A method as claimed in claim 16 wherein:
where there is at least one non-zero group (202) outside a subset of said groups, the inverse transform is calculated for all groups (202,204,206); and
where there are no non-zero groups (202) outside said subset, then the inverse transform is calculated for said subset and not for the remaining groups, and, if the modified coefficient is non-zero, pre-calculated values are used to reproduce the effect of the modified coefficient ([7,7]) in the inverse transform.

18. A method as claimed in claim 17 wherein said subset comprises the first three groups.

19. A method as claimed in claim 17 wherein said routines are further optimized such that:
where the only non-zero data groups (202) is the first group, the inverse transform is calculated in two dimensions for the non-zero data group (202) only, and if the modified coefficient is non-zero, pre-calculated values of the effect the modified coefficient has on each output value are then added; and/or
if only the DC coefficient (420) is non-zero, all output values are set to the value of the DC coefficient and if the modified coefficient is non-zero, pre-calculated values of the effect the modified coefficient has on each output value are then added.

20. Decode apparatus comprising means for calculating an inverse transform (114) for transform coded data, said coded data being arranged in groups of coefficients (202,204,206), wherein at least one coefficient is selectively modified to control mismatch, wherein there is further provided means for performing selectively the inverse transform so as to apply abbreviated processing to groups (204) composed entirely of zero-valued coefficients, and wherein, for the purpose of selecting whether abbreviated processing is to be applied, a data group (206) is considered a zero-valued group if the only non-zero coefficient contained therein is a coefficient modified for mismatch control.

21. Apparatus as claimed in claim 20 wherein said transform coded data is discrete cosine transform coded data.

22. Apparatus as claimed in claim 21 wherein said discrete cosine transform coded data forms part of MPEG-2 encoded video data.

23. Apparatus as claimed in claim 20 wherein the data is arranged in a two-dimensional array (200).

24. Apparatus as claimed in claim 23 wherein said two-dimensional array is an 8×8 array (200).

25. Apparatus as claimed in claim 20 wherein said apparatus applies a two-pass approach of multiple 1-D inverse transforms.

26. Apparatus as claimed in claim 25 wherein each data group is a column or a row of said array, depending on whether vertical inverse transform or horizontal inverse transform is performed first.

27. Apparatus as claimed in claim 25 wherein said apparatus is arranged such that the second pass inverse transform routine is made on the basis of the combinations of non-zero valued groups (202).

28. Apparatus as claimed in claim 27 wherein there is provided means for pre-storing a number of variations of a second pass process executable code, each variation corresponding to a combination of non-zero groups (202) present in the first pass, the code determining on which coefficients calculation is performed.

29. Apparatus as claimed in claim 28 wherein the second pass code is adapted to ignore data from unprocessed input groups.

30. Apparatus as claimed in claim 20 wherein said apparatus is arranged to use a direct 2-D implementation.

31. Apparatus as claimed in claim 30 wherein the groups assumed zero are 2-D blocks of coefficients.

32. Apparatus as claimed in claim 23 wherein the coefficient modified for mismatch control is the last coefficient.

33. Apparatus as claimed in claim 20 wherein there is provided means for pre-calculating an inverse transform of the data group containing the coefficient modified for mismatch control (206), said pre-calculation being used in calculating the inverse transform.

34. Apparatus as claimed in claim 20 wherein there is provided means for calculating the inverse transform for data groups (202) only when any of the coefficients, discounting any modification due to mismatch control, are non-zero and wherein, if mismatch is indicated, pre-calculated output values are used for the data group having the modified coefficient (206).

35. Apparatus as claimed in claim 20 wherein there is provided means for determining the number of non-zero data groups (202) and each of their positions before performing the inverse transform for any of the groups, and means for selecting a routine from a number of possible routines, depending on the number of non-zero groups and their positions (202).

36. Apparatus as claimed in claim 35 wherein said apparatus is arranged such that:
where there is at least one non-zero group (202) outside a subset of said groups, the inverse transform is calculated for all groups (202,204,206); and
where there are no non-zero groups (202) outside said subset, then the inverse transform is calculated for said subset and not for the remaining groups, and, if the modified coefficient is non-zero, pre-calculated values are used to reproduce the effect of the modified coefficient ([7,7]) in the inverse transform.

37. Apparatus as claimed in claim 26 wherein said subset comprises the first three groups.

38. Apparatus as claimed in claim 36 wherein the apparatus is arranged such that:
where the number of non-zero data groups (202) is one, the inverse transform is calculated in two dimensions for the non-zero data group only, and if the modified coefficient is non-zero, pre-calculated values of the effect the modified coefficient has on each output value are then added; and
if only a DC coefficient (420) is non-zero, all output values are set to the value of the DC coefficient and if the modified coefficient is non-zero, pre-calculated values of the effect the modified coefficient has on each output value are then added.

39. (canceled)
